(19) United States
(12) Patent Application Publication
(10) Pub. No.: US 2002/0129026 A1
(43) Pub. Date: Sep. 12, 2002

(54) Process for accessing information via a communications network

(76) Inventor: Patrick O. Reardon, Lawndale, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/093,902

(22) Filed: Mar. 8, 2002

Related U.S. Application Data
(60) Provisional application No. 60/274,768, filed on Mar. 9, 2001.

(51) Int. Cl. G06F 7/00

(52) U.S. Cl. 707/10

(57) ABSTRACT

A process for accessing information via a communications network, such as the world wide web, includes the steps of generating a combined request for access and a query. The request includes a domain name and a query for information or a solution associated with a web-site corresponding to the domain name. The request is routed to a server via the communications network using the domain name. The query is then analyzed and used to match an exact information or solution result found in association with the web-site. If found, the exact result is displayed. Alternatively, if an exact result is not found, an alternative query is determined at the server and a non-exact match search is conducted within the web-site for one or more results anticipated to approximate the exact result. The one or more non-exact results are then displayed for the user.

### RELATED APPLICATIONS

This application claims priority from United States Provisional Application Serial No. 60/274,768, filed Mar. 9, 2001.

### BACKGROUND OF THE INVENTION

The present invention generally relates to communication networks having searchable or calculatable information. More particularly, the present invention relates to a process for providing fast and direct access to an informational solution or result within a web-site or database of a communications network, such as the Internet, by combining a query with the web-site.

Most people are very familiar with the process of finding information within printed, tangible material such as dictionaries, encyclopedias, reference manuals, phone books, etc. For example, when searching for a “plumber” in the yellow pages, the user of the yellow pages opens at a point approximately 1/2 or 2/3 into the book which the searcher believes would approximate the location of the categories under “P”. Upon finding the “P” section, the searcher then searches through the pages to find the “Plumber” or “Plumbing” category within the “P” section. Upon finding this category, the searcher is then provided with information in the form of advertisements, addresses, and telephone numbers of the various plumbers within the yellow pages.

One of the frustrations of using the world wide web or Internet is although there is a tremendous amount of information that can be accessed, finding the exact information one is looking for can be a very difficult and time consuming task. The general process of finding information on the Internet, or other communications network, is illustrated in FIG. 1. The user first connects to a communications network (100), such as by connecting onto the world wide web. The user then selects a web-site that might have the result or the solution sought (102). For those who are familiar with Internet browsers and the world wide web, there are essentially two means of selecting such web-sites. If a user is not aware of a particular web-site, the user often enters a term or phrase into a search engine line. The search engine utilizes the terms within the phrase and provides a listing of addresses and links of web-sites that might contain the information or results sought by the user. Oftentimes, a large number of addresses and links are found, with only the determined most relevant ten or twenty displayed on the screen at any given time. Alternatively, the user knows the address of the web-site in which the user desires to search for the information.

Upon entering the address of the web-site into the Uniform Resource Locator (URL) box or line of the Internet browser or clicking the link, the address request is transmitted for access to the web-site through the communications network (104), which is followed by a communications delay. The server hosting the web-site receives the request for access, evaluates the request and sends a reply (106). There are communications delay (108) between the transmission of the request, the receipt of the request by the server, and the reply from the server to the user. If there is a lot of “traffic” or if the user has a relatively slow connection, the communication delays are greater and can become aggravating.

The reply from the server that the user receives is typically the display of the “home page” of the web-site or an error message indicating that the web-site could not be found from the given address (110). Many “home pages” include streaming graphics, video, etc. which may take some time to download and display. Sometimes the user must view these “introduction” graphics before searching for information on the web-site. In any event, the user views/reads the home page material for the information sought, links to the information sought, or an opportunity to make a term search within the web-site at the home page (112).

Typically, the information sought is not found on the home page. Thus, the user must send a new request by entering in the request into a search box or “clicking” on a hyperlink graphic displayed on the home page. The user sends this new request to the server (114), after which a communications delay (116) is experienced.

The server receives and evaluates this new request (118), and sends a reply to the new request, typically a web page of the web-site (120). There is a communications delay (122), after which the user receives the new reply/web page (124).

The user evaluates the reply by reading/viewing the web page for the specific information originally sought (126). If the user is lucky, the first link or search request finds the specific information sought. Otherwise, a series of links to different web pages of the web-site are selected until the specific information is found, or the user concludes that the information sought is not available through the particular web-site (128).

Clicking through a series of links or entering a series of search requests followed by communication delays and the review of material on each web page can take a significant amount of time before arriving at the specific information sought. This process is akin to making it mandatory that a person first view the initial pages of the white or yellow pages before actually looking for the desired category of services or telephone number of a specific person or business. If the user originally entered in a natural language search term or phrase and after “surfing” the first selected web-site determines that the information is not available through that particular web-site, the user must go through the same arduous process of one or more of the addresses or links displayed through the search engine.

Once the user finds the specific information sought on a particular web page of the web-site, it is possible to later return to that exact web page from the URL line. This is because the particular web page has a very specific address which is shown in the URL line above the web page, and is often shown on the bottom or top of a printed web page. However, such web page addresses are not intuitive in that the slashes, symbols, letters, terms, abbreviations, etc. may have very little correlation to the information actually obtained on the particular web page. Also, the exact web address must be entered into the URL in order to arrive at the web page. A single mistake will result in an error message or another web-page.

Accordingly, there is a need for a process of searching data within a communications network which is more friendly. There is also a need for such a process in which a user can combine a query with a request for access, such as a web-site address, for finding an informational solution or result in a single step. The present invention fulfills these needs and provides other related advantages.

### SUMMARY OF THE INVENTION

The present invention relates to a process which enables a user of a communications network, such as the world wide web, to access information in the form of a result or solution within an information source coupled to the network by incorporating a query with the access request so as to retrieve results in a single transmission loop.

In a particularly preferred embodiment, the process of the present invention comprises the steps of selecting from a group of domain names that are each associated with a web-site that is capable of receiving and processing a query. A request is entered into a uniform resource locator line of an Internet browser. The request includes the selected domain name, including a second level domain name and a top level domain name (e.g: .com, .net, .org., etc.). The top level domain name or second level domain name may include a term that identifies the associate web-site as being capable of receiving and processing the query. A query comprised of terms to be searched for or calculated using a processor or engine associated with the web-site corresponding to the domain name is entered into the URL as well, typically immediately following the domain names. The terms may comprise letters, words, mathematical symbols, or numbers. The query may also include parsing symbols between the terms to be matched or searched for.

Using the domain name, the request is routed via the communications network to a server hosting the web-site associated with the domain name. At the server, the query is matched to an exact information or solution result found in association with the web-site. The web-site may comprise a database, a web page, a calculating processor or any other source of information. The exact result is then sent to the user for display.

If an exact result is not found, an alternative query is determined at the server and a non-exact matched search is conducted within the web-site for one or more results anticipated to approximate the exact result. The determination of the alternative query can be performed using a misspelled word engine, an abbreviated word engine, an alternative word engine, a phonetic word engine or other applicable engine. The one or more non-exact results are then displayed on the user's computer. When non-exact results are displayed, preferably a notice informing the user that exact results were not found is displayed as well, with suggestions of query refinements to aid the user in finding an exact matching result.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flow chart illustrating the steps taken in searching for information on a communications network, such as the Internet, using conventional methodology;

FIG. 2 is a block diagram illustrating typical connection between a user and a database through a communications network;

FIG. 3 is a flow chart illustrating the steps taken in searching for information on a communications network in accordance with the present invention; and

FIG. 4 is a flow chart illustrating the steps taken in accordance with the present invention.

### DETAILED DESCRIPTION OF THE PREFERRED EMBODIMENTS

The present invention relates to a process which enables a user to directly access a query result, data or solution within a database or the like of a server or web-site by incorporating one or more elements of the query to be solved or searched along with the basic access elements, such as the domain name, in a manner such that access can bypass other information and/or obstacles and query for and retrieve a solution or a subset of information within the database or the like. The present invention has particular use in accessing information via a communications network, such as the world wide web. By combining a query for data to be searched or solved along with access information, the typical “chatter” of multiple transmissions and communication delays that are presently experienced when searching for data on the world wide web can be significantly reduced.

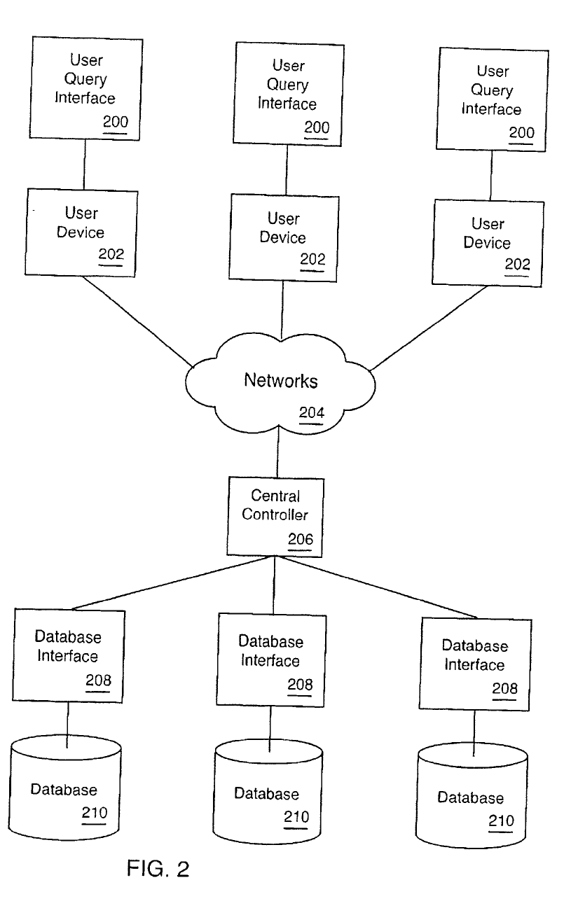

With reference to FIG. 2, a block diagram is shown illustrating the typical connection of various components of a communications network. Such communications network includes one or more user query interfaces 200 which are connected to user devices 202. The user device 200 may comprise a desktop computer, a laptop, a cell phone, a Personal Digital Assistant, etc. The user query interface 200 typically comprises a monitor or display component of the device 202. As the present invention has particular applicability to searching for information on the world wide web, the foregoing explanation will be directed to accessing information through an Internet browser of a computer connected to the world wide web. However, it should be understood that the inventive concept of combining access information, such as a domain name, with a query for information or a solution to be found or determined at the web-site, database, etc. is not necessarily limited to such application.

The user devices 202 are connected to a network 204 which can be any type of communication network, including the Internet, an internal network, cell phone network, etc. This network 204 is likewise connected to a central controller 206, which can be a web server, file server, database server, etc. This central controller 206 interfaces with one or more databases 210 or other electronic or digital information sources through a database interface 208 or the like which may comprise a web server, database client software, pass-through software, etc.

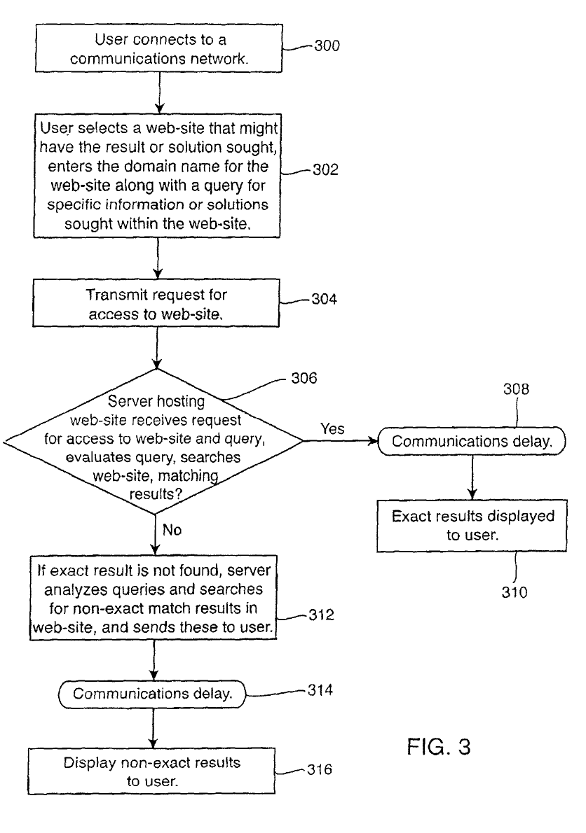

With reference now to FIG. 3, the user connects to a communications network (300), such as that illustrated in FIG. 2, and selects a web-site that might have the result or solution sought. The user enters the domain name for the web-site which includes top level domain name (e.g. .com, .net, .org, etc.) and the second level domain name (e.g. for the Ford Motor Company, “Ford”). Along with the domain name for the web-site selected, the user enters a query for specific information or solution sought within the web-site (302). The user then transmits this access/query to the web-site (304), such as the illustrated network 204 in FIG. 2 using means such as a modem or the like. This transmission results in a communications delay.

A server hosting the web-site receives the request to access the website, evaluates the query, and searches the web-site for an exact matching result (306). If an exact matching result is found, the server sends a reply to the user including the exact matching result. After a communications delay (308), the exact result is displayed to the user (310), such as through the user query interface 200 of the user device 202. However, if an exact result is not found, the server analyzes the query for alternative queries and searches for non-exact matching results in the web-site, such as the illustrated databases 210, and sends these non-exact match results to the user (312). After a communications delay (314), the non-exact matching results are displayed to the user (316).

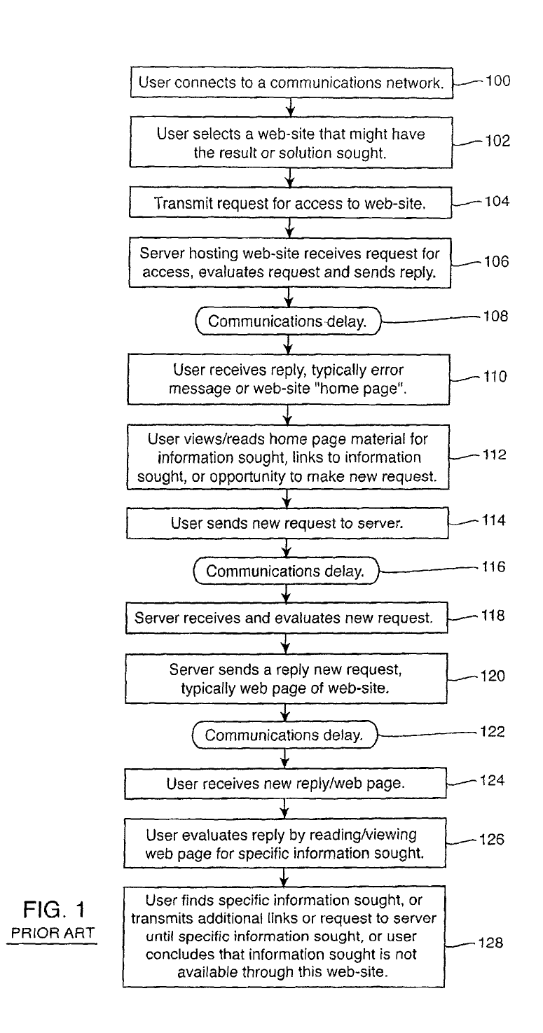

It will be readily apparent to those skilled in the art that the present invention provides many benefits to the end user, including the saving of online time and the frustration of “surfing” the Internet to find a result or answer. As described above, the present method of obtaining information on the Internet requires one to enter the domain name into the URL line of the Internet browser or click on a domain name address link which results in an introductory home page or starting point. Oftentimes, many links in the form of hyperlinks or graphic user interface buttons or term searches must be selected or conducted before obtaining the information desired. However, using the present invention, either the exact matching result or close non-exact matching results are returned to the end user without the time consuming review and “chatter” process illustrated in FIG. 1. All of the activity involved in the access and query is conducted at the server side of the communications network. That is, the query is matched to an exact information or solution result found in association with the web-site, or if the exact information is not found, alternative queries are determined at the server and subsequent searches, calculations, etc. are performed at the server side so that the end user receives pertinent information regarding the query in a single transmission step. It is anticipated that the end users of communication networks, such as the Internet, will find such a method of finding information or obtaining results much more user friendly than the current process.

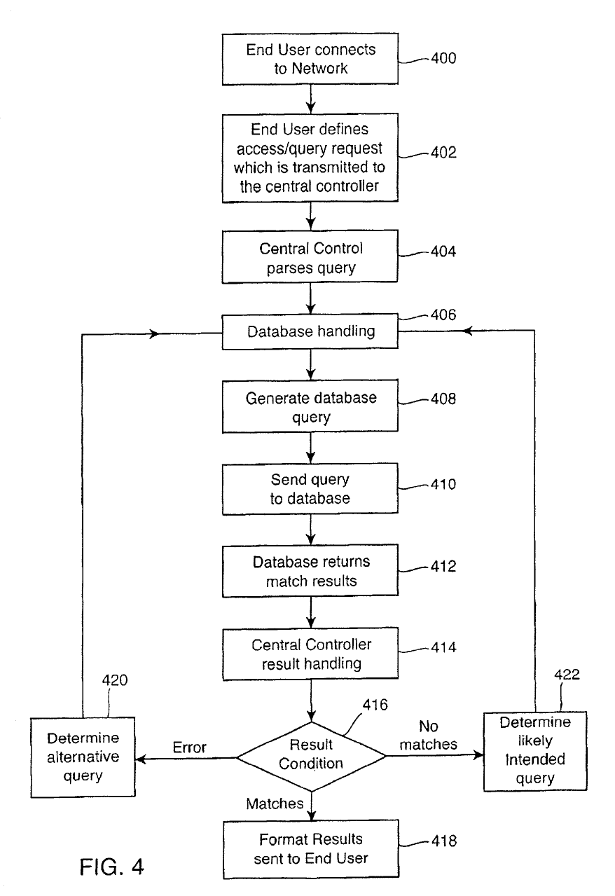

With reference now to FIG. 4, the process of the present invention will be described more fully. As described above, the end user connects to a network 400. The end user must select a central controller, in the form of a server, etc., which is modified, such as by software, to recognize both the access request and the query, and which is capable of interpreting and searching for results based on the query. The invention contemplates the use of a term or element within the domain name that classifies the web-site or other informational database or processor associated with the domain name as being capable of performing such functions. For example, the second level domain name may include the term “quick” or “qs” for “quick search”. This term or element would identify the web-site as supporting the invention. Such term or element may instead comprise the top level domain name once it is available.

The end user then defines a query (402). Initially, the end user may seek assistance at a web-site which explains the process of the present invention and how to generate an access/query with suggestions, frequently asked questions, etc. Due to the fact that the methodology of the present invention is user friendly and intuitive, the end user will most likely only need to visit the explanatory web-site once, or may even be able to create the combined access and query with little trial and error. For example, if an end user would like to find a part for a Ford Mustang, the user could enter into the URL line of the Internet browser “Ford.com/parts”. Assuming that this web-site implements the teachings of the present invention, the domain name “Ford.com” would provide access to the web-site, and the search term “parts” would be used in extracting results for display to the end user. As broad searches may extract too large a number of results, the invention contemplates displaying a limited number of search results. Preferably, a notification is provided to the end user of the large number of results found. Also, such notification can be used to inform the end user that an exact match was not found and provide suggestions to the end user on how to improve the query. In this example, instead of merely searching for “parts”, the end user could refine the query to include secondary, tertiary, etc. focuses. For example, “Ford.com/parts/1996/Mustang/transmission.”

After typing or entering the domain name and query into the URL line of the Internet browser, the access/query is transmitted to the central controller (402). The central controller, such as the web-site server, parses the query (404). In the examples provided above, the terms of the query were separated using symbols, such as the forward slash symbol above. The invention contemplates using such parsing or separating symbols to assist the central controller in interpreting the query. However, the invention is not limited to such as the central controller can be programmed so as to identify separate terms and phrases. Thus, the central controller would equate the access/query “Ford.compartsmustang1996transmission” with that above. Also, central controller can be designed so as to provide the same search results if the query terms or phrases are in differing orders. Thus, “Ford.com/1996/mustang/parts/transmission” would yield the same results.

Once the central controller parses the query (404), and determines the database to be searched (406), the generated database query (408) is sent to the database (410) where results are searched and matched with the query. If an exact match or matches are found, the database returns the matched results (412) to the central controller for result handling (414) and the exact match result condition (416) is recognized and the formatted exact results are sent to the end user (418).

However, as described above, if an exact match or matches are not found based upon the user defined query, the central controller recognizes this result condition (416) and determines an alternative query (420) based upon the user defined query. This query is sent through the database to find matching results as described above. If no matches are found, the central controller then determines the likely intended query (422) and searches for exact and non-exact matches. The process of determining alternative queries or likely intented queries includes the recognition of common abbreviations, common misspellings, phonetic equivalents, substitute words, etc. Thus, the central controller includes abbreviated word engines, alternative word engines, phonetic engines, etc. in order to determine the alternative queries in an effort to provide the end user useful results.

The end user obtains either exact matching results, or non-exact matching results with accompanying notification. It is important to note that the end user is not merely provided web-site addresses or other links as is currently done. Instead, the end user actually obtains results from the web-site or other informational source connected to the communications network. In the provided example, the end user would obtain information regarding transmission parts for a 1996 Ford Mustang. The results themselves may include links to web pages for additional information, etc., but the invention is intended to present information or results to the end user in one transmission step. If the end user does not obtain desirable results from the query, the end user can modify the query or present the query at another web-site. For example, the web-site “Ford.com” may not include information regarding transmission parts for a 1996 Mustang. However, the web-site for an automotive parts store may be able to provide this information with the same query. The end user will be able to quickly obtain search results, or realize that such results are not obtainable in the selected web-site, very quickly. This is in contrast to the present method of starting at a home page or the like and “surfing” the web-site for several minutes before obtaining the results or determining that the web-site does not contain the information the end user is looking for.

Another benefit of the present invention is that the end user can conduct an access/search at any page or point on the Internet. For example, if the end user happens to be reading material on a given web page and comes across a term that he or she is not familiar with, the end user can enter into the URL line “dictionaryquick.com (term to be searched)”. If the dictionary web-site implements the present invention, the definition of that particular term is provided to the end user immediately as an initial response to the transmission. If the end user misspelled the term, the central controller of the web-site would correct the spelling and provide the definition for the correctly spelled term or provide the definition of a phonetically equivalent, etc. Thus, the end user would obtain either an exact matching result or beneficial non-exact matching results. The end user could then “click” the “back button” of the Internet browser to return to the page he or she was previously viewing.

The present invention can be beneficially implemented into virtually every web-site available on the Internet. For example, if an end user is interested in finding which flights were available between Los Angeles and Paris, the end user could enter “flightsqs.com/lax/paris” and be provided with a listing. The central controller server could be designed such that flights of that day are displayed first, followed by subsequent days for the various airlines. Of course, a particular airline could implement the invention so that only the flights between Los Angeles and Paris for that particular airline would be displayed. Other applications include searching classified advertisements, determining postal codes, local time at geographic locations, scores of sporting events, weather at geographic locations, white and yellow pages, other information, etc.

The invention is not merely limited to searching for word terms or phrases or numerical zip codes or telephone numbers found within a web-site or database. The invention also contemplates the implementation of a multifunction calculator or processor as a solution engine at the server. As such, the end user could determine the exchange rate of a given currency by entering “currency.com/120usd/yen” to obtain the equivalent yen of $120.00. Also, mathematical equations could be solved by creating these as a query at the end of the domain name. Certain predefined symbols would represent mathematical functions. Thus, entering “calculator.com/2*2” would yield a result of “4”. Also, a progressive solution to the mathematical query could be provided to the end user. Such solution would be displayed to the end user in a step-by-step manner as if the end user had performed the mathematical calculation by long hand, or as printed on a paper roll of a calculator machine.

Although the preferred application of the present invention is the world wide web, it is applicable in other communications networks as well. Such an embodiment is when the communications network is a telephone system. The access/query would be the maximum digits that a phone will accept before the RBOC or the like disregards the remaining digits or symbols. Currently, the RBOC will only process a certain number of digits, the balance being discarded, but it is anticipated that such could be changed to incorporate the present invention. Whereas the end user would enter flights.com/LAX/New Orleans for gate information into the URL, using the telephone communications network, the end user would dial an area code controlling one leg of the flight, e.g. “310”, “213”, “714”, etc. for LAX. A designated number, e.g. 555-5555, would be the necessary access. The rest of the string after the access number comprising the digits 0-9, and * or # would communicate the desired query limitations. For instance, “679” would be for MSY, “358” would be for DLT or Delta Airlines. The “#” might precede the flight number, as #221234 for American Airlines Flight 1234, and the “*” could be used as the parsing signal. Thus, “310-555-5555*679*#221234” would be specific for both legs of the flight and specific carrier; and “310-555-5555*679*358” would represent one specific leg of the flight, carrier and flight number. In the event insufficient digit space is allowed, or the entered digits or symbols could have various meanings, the services server would prompt an IVR (Interactive Voice Response) or some other relevant technology to prompt the user to resolve the ambiguity or add the additional terms/digits and symbols to finalize the query and resolve the ambiguity.

It will be appreciated by the reader that the present invention provides advantages over currently existing searching methods on communications networks, such as the Internet, as the user is able to simultaneously connect to and receive a useful response by entering in the appropriate information on the URL line. Aside from saving time and frustration, the present invention provides a user with exact matches of the query, close matches to the query, or suggested modifications to the query. As the end user is able to accomplish all of this with a single “click” or by pressing the “enter” key, the end user can quickly obtain this information. This also allows the end user to receive the requested information and click by to where he or she was with one click of the browsers “back” button.

Although several embodiments have been described in detail for purposes of illustration, various modifications may be made without departing from the scope and spirit of the invention. Accordingly, the invention is not to be limited, except as by the appended claims.

What is claimed is:

1. A process for accessing information via a communications network, comprising the steps of:
generating a combined request for access to an electronic informational source coupled to the communications network and a query for one or more results from the informational source;
accessing the informational source and matching the query to an exact information or solution result found in association with the informational source; and
providing the exact result if found, or alternatively, if an exact result is not found, determining an alternative query at the informational source and conducting a non-exact match search within the informational source for one or more results anticipated to approximate the exact result and providing the one or more non-exact results.

2. The process of claim 1, including the steps of:
entering a request into an Internet browser, the request including a domain name and a query for information or a solution associated with a website corresponding to the domain name;
routing the request using the domain name via the communications network to a server;
accessing the web-site and matching the query to an exact information or solution result associated with the web-site; and
displaying the exact result if found, or alternatively, if an exact result is not found, determining an alternative query at the server and conducting a non-exact match search within the web-site for one or more results anticipated to approximate the exact result and displaying the one or more non-exact results.

3. The process of claim 2, wherein the entering step includes the step of entering a top level domain name and a second level domain name followed by the query.

4. The process of claim 3, wherein either the top level domain name or second level domain name includes a term that identifies the associated website as being capable of receiving and processing the query.

5. The process of claim 2, including the step of entering a domain name selected from a group of domain names that are each associated with a web-site that is capable of receiving and processing the query.

6. The process of claim 2, wherein the entering step includes the step of entering the domain name and query into a uniform resource locator line of the Internet browser.

7. The process of claim 1, wherein the query comprises terms to be searched or calculated.

8. The process of claim 7, wherein the terms comprise at least one of: letters, words, mathematical symbols, or numbers.

9. The process of claim 7, wherein the entering step further includes the step of entering parsing symbols between the terms to be matched or searched for.

10. The process of claim 1, wherein the step of determining an alternative query step comprises using a misspelled word engine.

11. The process of claim 1, wherein the step of determining an alternative query step comprises using an abbreviated word engine.

12. The process of claim 1, wherein the step of determining an alternative query step comprises using an alternative word engine.

13. The process of claim 1, wherein the step of determining an alternative query step comprises using a phonetic engine.

14. The process of claim 2, wherein the web-site comprises at least one of: a database, a web page, or a calculating processor.

15. The process of claim 1, including the step of displaying suggested query refinements if a non-exact match result is found or no results are found.

16. A process for accessing information via a communications network, such as the world wide web, comprising the steps of:
entering a request into an uniform resource locator line of an Internet browser, the request including a domain name, including a second level domain name and a top level domain name, followed by a query comprised of terms to be searched for or calculated using a processor or engine associated with a web-site corresponding to the domain name;
routing the request using the domain name via the communications network to a server;
accessing the web-site and matching the query to an exact information or solution result associated with the web-site; and
displaying the exact result if found, or alternatively, if an exact result is not found, determining an alternative query at the server and conducting a non-exact match search within the web-site for one or more results anticipated to approximate the exact result and displaying the one or more non-exact results.

17. The process of claim 16, wherein either the top level domain name or second level domain name includes a term that identifies the associated web-site as being capable of receiving and processing the query.

18. The process of claim 16, including the step of entering a domain name selected from a group of domain names that are each associated with a web-site that is capable of receiving and processing the query.

19. The process of claim 16, wherein the terms comprise at least one of: letters, words, mathematical symbols, or numbers.

20. The process of claim 19, wherein the entering step further includes the step of entering parsing symbols between the terms to be matched or searched for.

21. The process of claim 16, wherein the step of determining an alternative query step comprises using a misspelled word engine, an abbreviated word engine, an alternative word engine, or a phonetic engine.

22. The process of claim 16, wherein the web-site comprises at least one of: a database, a web page, or a calculating processor.

23. The process of claim 16, including the step of displaying suggested query refinements if a non-exact match result is found or no results are found.

24. A process for accessing information via a communications network, such as the world wide web, comprising the steps of:
selecting from a group of domain names that are each associated with a web-site that is capable of receiving and processing a query;
entering a request into an uniform resource locator line of an Internet browser, the request including the selected domain name, including a second level domain name and a top level domain name, followed by a query comprised of terms to be searched for or calculated using a processor or engine associated with the web-site corresponding to the domain name;
routing the request using the domain name via the communications network to a server hosting the web-site;
accessing the web-site and matching the query to an exact information or solution result associated with the web-site;
displaying the exact result if found, or alternatively, if an exact result is not found, determining an alternative query at the server and conducting a non-exact match search within the web-site for one or more results anticipated to approximate the exact result and displaying the one or more non-exact results; and
displaying suggested query refinements if a non-exact match result is found or no results are found;
wherein either the top level domain name or second level domain name includes a term that identifies the associated web-site as being capable of receiving and processing the query.

25. The process of claim 24, wherein the terms comprise at least one of: letters, words, mathematical symbols, or numbers.

26. The process of claim 24, wherein the entering step further includes the step of entering parsing symbols between the terms to be matched or searched for.

27. The process of claim 24, wherein the step of determining an alternative query step comprises using a misspelled word engine, an abbreviated word engine, an alternative word engine, or a phonetic engine.

28. The process of claim 24, wherein the web-site comprises at least one of: a database, a web page, or a calculating processor.
